(19) United States
(12) Patent Application Publication
(10) Pub. No.: US 2011/0310136 A1
(43) Pub. Date: Dec. 22, 2011

(54) LIQUID CRYSTAL DISPLAY AND DRIVING METHOD THEREOF

(75) Inventors: Sang-kyun IM, Seoul (KR); Ji-yong PARK, Suwon-si (KR); Dong-wook KIM, Suwon-si (KR); Min-jung KIM, Seoul (KR)

(73) Assignee: SAMSUNG ELECTRONICS CO., LTD., Suwon-si (KR)

(21) Appl. No.: 13/162,994

(22) Filed: Jun. 17, 2011

(30) Foreign Application Priority Data
Jun. 17, 2010 (KR) 10-2010-0057627

(51) Int. Cl. G09G 5/10; G09G 3/36

(52) U.S. Cl. 345/690; 345/88

(57) ABSTRACT

A Liquid Crystal Display (LCD) and a driving method thereof are provided. The LCD includes: a display panel part including a pixel, the pixel including a plurality of sub-pixels; a panel driver which drives the sub-pixels; a backlight part which emits a light of different colors to the display panel part; a backlight driver which provides the light of the colors corresponding to fields of a frame in sequence by sequentially driving the backlight part according to the fields; and a controller which controls the panel driver to represent a color of the pixel of the frame by selectively using one or more of the sub-pixels of the pixel. Hence, the liquid crystal stress can be drastically improved without a loss of brightness.

### CROSS-REFERENCE TO RELATED APPLICATION

This application claims priority from Korean Patent Application No. 10-2010-0057627, filed on Jun. 17, 2010 in the Korean Intellectual Property Office, the entire disclosure of which is incorporated herein by reference.

### BACKGROUND

1. Field

Exemplary embodiments relate to a liquid crystal display and a driving method thereof, and more particularly to a liquid crystal display with a color filter removed and a driving method thereof.

2. Description of the Related Art

A liquid crystal display is a display device which represents an intended image by forming a liquid crystal layer having dielectric anisotropy on a transparent insulating substrate on upper and lower sides and changing a molecule arrangement of a liquid crystal material by adjusting an intensity of an electric field formed in the liquid crystal layer, thereby regulating the amount of the light penetrating the transparent insulating substrate.

The liquid crystal display may employ a Thin Film Transistor (TFT) Liquid Crystal Display (LCD) using a TFT as a switching element. Such a LCD includes a liquid crystal panel for displaying the image with pixels including gate lines and data lines crossing each other, a driver for driving the liquid crystal panel, a backlight unit for emitting light to the liquid crystal panel, and a color filter for passing the emitted light to the liquid crystal panel.

The LCD is implemented by placing red (R), green (G), and blue (B) sub-pixels representing an R, G and B three-color image in one liquid crystal pixel that is a minimum unit of the pixel, and installing R, G and B color filters in a front part of the sub-pixel so as to pass only the R, G and B lights per sub-pixel of the white light emitted from the backlight unit.

Though the color filter is an important element for representing the color image, the color filter causes light loss due to the light absorption.

Meanwhile, a Digital Information Display (DID) device may emit light for a long period of time. When a particular logo or On Screen Display (OSD) is fixed to a certain position, the display device may be subject to an afterimage (i.e., a burned in image). Related art displays have been implemented the LCD, rather than a Plasma Display Panel (PDP) because of the burn-in screen effect.

The DID device used, for example, in airports may use an LCD panel, which may have a lifespan of 3 to 5 years. However, after one year, the LCD panel may be subject to the afterimages and a panel replacement incurs significant cost. To address those shortcomings, the related art displays prevent the afterimage by moving the logo or changing the OSD at regular time intervals. However, it may be difficult to move the logo. Furthermore, when the movement range of the log is small, the prevention of the afterimage may be ineffective.

### SUMMARY

One or more exemplary embodiments provide a liquid crystal display having an expanded lifespan using a field sequential driving scheme and a sub-pixel control scheme, and a driving method of the liquid crystal display.

According to an aspect of an exemplary embodiment, there is provided a Liquid Crystal Display (LCD) including: a display panel part including a pixel, the pixel including a plurality of sub-pixels; a panel driver which drives the plurality of sub-pixels; a backlight part which emits light of different colors to the display panel part; a backlight driver which provides the light of the different colors corresponding to fields of a frame in sequence by sequentially driving the backlight part according to the fields; and a controller which controls the panel driver to represent a color of the pixel of the frame by selectively using one or more of the sub-pixels of the pixel.

The controller may select a different sub-pixel combination used to represent the frame color, in every frame.

The controller may sequentially select sub-pixels used to represent the frame color in every frame so as to cause a number of times the sub-pixels of the pixels of the display panel part are used in every frame to be equal.

The controller may select the sub-pixels in every two frames to cause the number of times the sub-pixels in the corresponding frames are used to be equal.

The panel driver may drive an unselected sub-pixel of the sub-pixels to reduce a light transmittance of the unselected sub-pixel.

The panel driver may drive the unselected sub-pixel of the sub-pixels so that the unselected sub-pixel represents a gray or a black color.

A polarity of the frame may change on a frame-by-frame basis, and the controller may select sub-pixels used to represent the frame color at preset frame periods to cause a sum of a polarity of the sub-pixels in the corresponding frame period to be zero.

The LCD may be an LCD without color filters.

The LCD may be used in a Digital Information Display (DID) device.

According to an aspect of another exemplary embodiment, there is provided a method of driving an LCD, the method including: providing light of different colors corresponding to fields of a frame in sequence according to the fields; when a current frame is input, representing a color of a pixel of the LCD by selectively using one or more of sub-pixels of the pixel; and when a next frame is input, representing a color of the pixel by selectively using one or more of the sub-pixels, wherein a sub-pixel combination used to represent a frame color of the current frame is different from a sub-pixel combination used to represent a frame color of the next frame.

Sub-pixels used to represent the frame color may be selected in sequence in every frame so as to cause a number of times the sub-pixels of the pixels are used in every frame to be equal.

The sub-pixels may be selected in every two frames to cause a number of times the sub-pixels are used in the every two frames to be equal.

An unselected sub-pixel of the sub-pixels may be driven to reduce a light transmittance of the unselected sub-pixel.

An unselected sub-pixel of the sub-pixels may be driven so that the unselected sub-pixel represents a gray or a black color.

A polarity of a frame may change on a frame-by-frame basis, and sub-pixels used to represent each frame color may be selected at preset frame periods to cause a sum of a polarity of the sub-pixels in the corresponding frame period to be zero.

The LCD may be an LCD without color filters.

The LCD may be used in a Digital Information Display (DID) device.

According to an aspect of another exemplary embodiment, there is provided a method of driving a display panel, the method including: when a current frame is input, representing a color of a pixel of the display panel by selectively using one or more of sub-pixels of the pixel; and when a next frame is input, representing a color of the pixel by selectively using one or more of the sub-pixels, wherein a sub-pixel combination used to represent a frame color of the current frame is different from a sub-pixel combination used to represent a frame color of the next frame, and the sub-pixels provide light of different colors corresponding to fields of a frame in sequence according to the fields.

As set forth above, by applying a field sequential driving scheme and a sub-pixel control scheme to an LCD without color filters, a liquid crystal stress can be drastically improved without a loss of brightness.

Additional and/or other aspects will be set forth in part in the description which follows and, in part, will be obvious from the description, or may be learned by practice of the exemplary embodiments.

### BRIEF DESCRIPTION OF THE DRAWINGS

These and/or other aspects will become apparent and more readily appreciated from the following description of the exemplary embodiments, taken in conjunction with the accompanying drawings of which:

FIGS. 1A and 1B illustrate a Liquid Crystal Display (LCD) with color filters removed;

FIGS. 2A and 2B illustrate an LCD construction according to an exemplary embodiment;

FIGS. 3A and 3B illustrate an LCD driving method according to an exemplary embodiment;

FIG. 4 illustrates a field sequential driving method according to an exemplary embodiment;

FIGS. 5A, 5B and 5C illustrate a sub-pixel driving method according to one or more exemplary embodiments;

FIG. 6 illustrates an LCD driving method according to an exemplary embodiment; and

FIG. 7 is a flowchart of an LCD driving method according to an exemplary embodiment.

### DETAILED DESCRIPTION OF THE EXEMPLARY EMBODIMENTS

Reference will now be made in detail to exemplary embodiments, examples of which are illustrated in the accompanying drawings, wherein like reference numerals refer to the like elements throughout. The exemplary embodiments are described below to explain the present disclosure by referring to the figures. Hereinafter, expressions such as “at least one of,” when preceding a list of elements, modify the entire list of elements and do not modify the individual elements of the list.

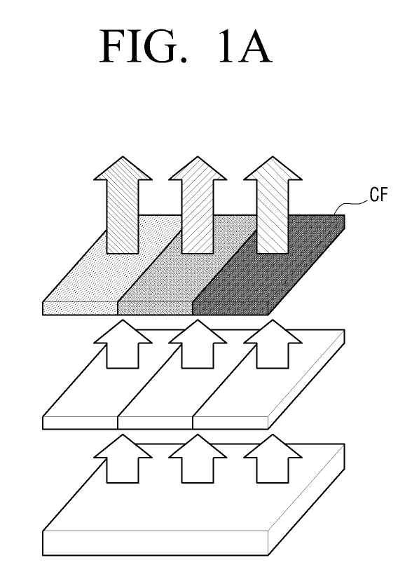

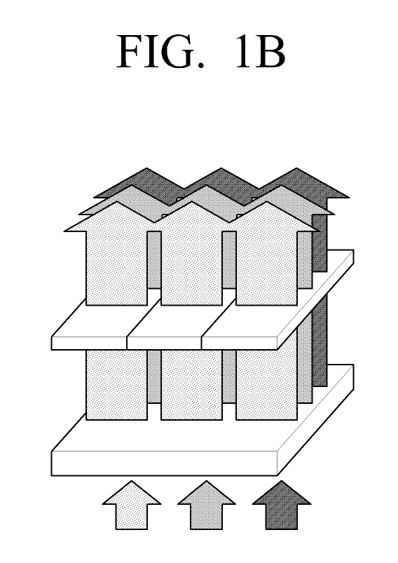

FIGS. 1A and 1B depict a Liquid Crystal Display (LCD) construction with color filters removed.

FIG. 1A depicts a related art LCD construction. Specifically, in FIG. 1A, the structure of a related art LCD device is depicted.

The LCD applies an electric property of the liquid crystal in a state of matter between liquid and solid, to a display device.

The LCD forms a liquid crystal element arrangement in a certain direction according to an electric field, and selectively passes light having a wave of a certain direction. That is, the liquid crystal is linearly arranged by the electric field according to molecular structure properties, and is twistable by a unit of 90 degrees between layers according to mechanical properties. The 90-degree based twisted arrangement is referred to as a Twisted Nematic (TN), and a 270-degree based twisted arrangement is referred to as a Super Twisted Nematic (STN). When the electric field is given to a stick-type liquid crystal in between two layers, the location of the liquid crystal changes according to the direction of the electric field and the light amount to pass varies accordingly. That is, the liquid crystal is twisted by the effective voltage between a sub-pixel electrode and a common electrode to thus regulate the light transmittance.

Referring to FIG. 1A, the related art LCD device uses color filters to represent colors. A pixel unit of the filters includes three sub-pixels (i.e., RGB). The RGB in the LCD may be in a grid structure. As for a screen resolution in an LCD monitor, a number of pixels in a horizontal direction relates to the horizontal resolution, and a number of pixels in a vertical direction indicates a vertical resolution. Using the color filters, a spatial scheme represents a hue by dividing one pixel into three spaces of the red, the green, and the blue and mixing the amount of the light emitting from the spaces.

FIG. 1B depicts a construction of a Color Filterless (CFL) LCD according to an exemplary embodiment.

The CFL-LCD adopts a field sequential driving scheme which determines the hue according to how often the red, green, and blue lights are turned on within too a short time to be perceived by eyes, without dividing the pixel into the spaces.

Unlike the related art color LCD, the field sequential driving scheme does not require the color filters. Hence, the field sequential driving scheme can achieve high transmittance without the light reduction.

In particular, the field sequential driving scheme divides a frame duration into three field intervals (or sub-frame intervals, i.e., into a red field interval, a green field interval, and a blue field interval. A data driving circuit (not shown) of the LCD outputs a red data signal during the red field interval of one frame duration, the red light source of the three light sources of the backlight emits the light, and a red light corresponding to the red data signal is passed to the liquid crystal panel.

Moreover, a green data signal is fed to the data driving circuit during the green field interval, the green light source of the backlight emits the light during this interval, and a green light corresponding to the green data signal is passed to the liquid crystal panel.

Furthermore, a blue data signal is output from the data driving circuit during the blue field interval, the blue light source of the backlight emits the light during this interval, and a blue light corresponding to the blue data signal is passed to the liquid crystal panel.

In response to the red, green, and blue lights successively input to the liquid crystal panel from the RGB light sources, each pixel of the liquid crystal panel generates an image.

As such, the data signals for the red, the green, and the blue are sequentially fed to each pixel of the liquid crystal panel once in every field within one frame duration, the corresponding red, green, blue light sources of the backlight are driven in order, and thus the red, the green, and the blue are provided to the liquid crystal panel in sequence. Accordingly, the liquid crystal panel can display the image corresponding to the RGB data provided for the one frame duration.

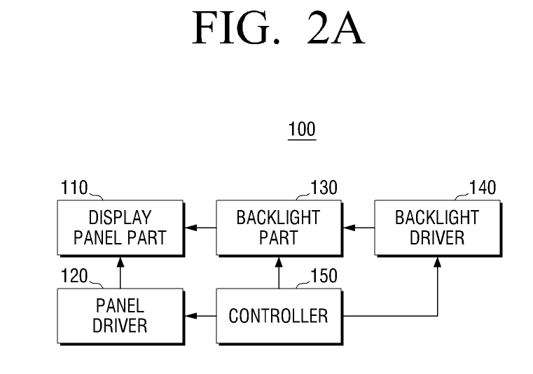

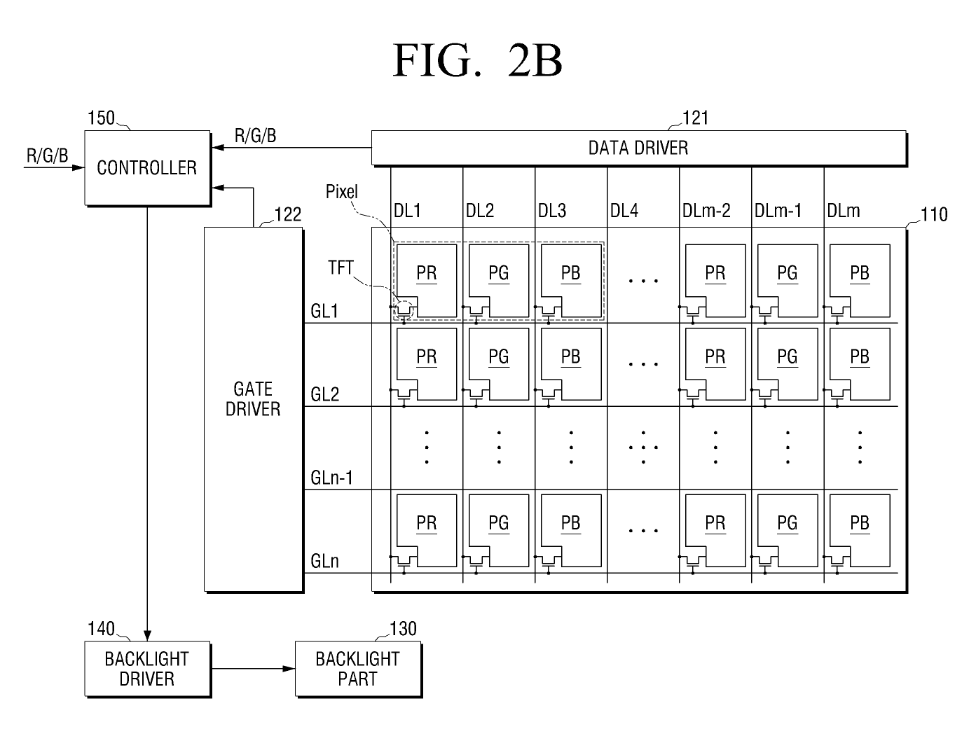

FIGS. 2A and 2B illustrate an LCD 100 according to an exemplary embodiment. Referring to FIG. 2A, the LCD 100 includes a display panel part 110, a panel driver 120, a backlight part 130, a backlight driver 140, and a controller 150.

The LCD 100 can be implemented without the color filters, i.e., using the CFL-LCD. That is, the LCD 100 according to the present exemplary embodiment represents color using a Field Sequential Color (FSC) system which is a sequential representation scheme by determining colors according to a time for which red (R), green (G), and blue (B) backlight sources are provided during too short a period of time to be perceived with eyes, without spatially dividing the pixel. The FSC can allow a user to experience a color image by using R, G, B Light Emitting Diodes (LEDs) as the backlight sources, dividing a screen image signal to image signals of the R, G, B colors, sending the R image signal to the liquid crystal panel while the R-LED is turned on, sending the G image signal to the liquid crystal panel while the G-LED is turned on, and sending the B image signal to the liquid crystal panel while the B-LED is turned on, in sequence.

The display panel part 110 spatially forms one frame with a plurality of pixels. Each pixel can include a plurality of sub-pixels. For example, the pixel can include three sub-pixels corresponding to a plurality of lights, for example, the red, green, blue (R, G, B) lights.

The panel driver 120 can drive the plurality of the sub-pixels individually under the control of the controller 150, to be explained below.

In detail, the panel driver 120 can drive the unselected sub-pixel such that the transmittance of the unselected sub-pixel among the sub-pixels decreases. For example, the panel driver 120 can drive the unselected sub-pixel such that the unselected sub-pixel of the sub-pixels represents the gray or black (gray scale 0) color.

Meanwhile, the panel driver 120 may include a data driver 121 which supplies video data to data lines, and a gate driver 122 which supplies scan pulses to gate lines, as illustrated in FIG. 2B. Detailed explanations of the drivers 121 and 121 will be provided below with reference to FIG. 2B.

The backlight part 130 is disposed under the display panel part 110, and may include three light sources which produce the red, green, and blue lights (R, G, B). For example, the three light sources may employ red, green, and blue LED-Backlight Units (BLUs), though it is understood that another exemplary embodiment is not limited thereto 0. For example, according to another exemplary embodiment, the three light sources may employ Cold Cathode Fluorescence Lamps (CCFL), External Electrode Fluorescence Lamps (EEFL), etc.

The backlight part 130 emits the light to the display panel part 110 from the rear side of the display panel part 110, i.e., in an opposite side of the image display.

The backlight driver 140 switches the light sources of the backlight part 130 on and off under the control of the controller 150. The backlight driver 140 can produce the light of the colors corresponding to the fields in sequence by sequentially driving the backlight part 130 according to the fields of the frame. Herein, the frame indicates a display duration of one screen displaying one complete image by applying the data of one screen to the pixels. For example, some standards define a frame duration as 1/60^{th} of a second (60 Hz) (e.g., NTSC) and as 1/50^{th} of second (50 Hz) (e.g., PAL).

Specifically, the backlight driver 140 sequentially switches the LED light sources of the three colors R, G, and B on and off at too short a time interval to be separately perceived by human eyes. The timing for switching the light sources on and off may be set to match the color of the light source switched on with the color of the data provided to the display panel part 110.

The controller 150 may control the panel driver 120 to divide one frame interval into a plurality of field intervals and to supply the data to the data lines in sequence. Furthermore, the controller 150 may control the panel driver 120 to represent the color of the corresponding frame in every frame by selectively using some of the sub-pixels of the corresponding frame. In more detail, the controller 150 may control the panel driver 120 in every frame to select a different sub-pixel combination from the sub-pixels used to represent the frame color.

Moreover, the controller 150 may sequentially select the sub-pixels used to represent the frame color in every frame to cause the number of times the sub-pixels of the pixels of the display panel part 110 are used to be equal. For example, the controller 150 may select the sub-pixels in every two frames to cause the number of times the sub-pixels in the corresponding frames are used to be equal.

Meanwhile, the LCD, which is a non-limiting example of the display panel part 110, may be driven using an inversion driving method. That is, when a DC voltage is applied for a duration of time, property deterioration may result. To prevent this, the LCD may be driven by periodically changing the polarity of the applied voltage. Hence, the LCD pixels are subject to the polarity inversion.

The inversion driving method may use at least one of a frame inversion, a line inversion, a column inversion, and a dot inversion.

The frame inversion applies the same polarity of data voltage to a liquid crystal on a frame basis with respect to a common electrode voltage. For example, when a data voltage of positive polarity is applied to a first frame, a data voltage of negative polarity is applied to a second frame that is adjacent to the first frame.

The line inversion is a polarity inversion driving method that may used for low resolutions (e.g., VGA, SVGA, etc.), and applies a data voltage to alter a polarity of a pixel on a horizontal line basis. For example, when a positive polarity data voltage is applied to an odd line and a negative polarity data voltage is applied to an even line, voltages of opposite polarity are applied to a next frame.

The column inversion applies data voltage of a same polarity in a vertical direction and a data voltage of opposite polarity in a horizontal direction.

The dot inversion may be applied to high resolutions (e.g., XGA, SXGA, UXGA, etc.). In every direction from top to bottom and from left to right, polarity of data voltage between adjacent pixels is opposite from one another.

While any one of the above-described driving methods may be used in an exemplary embodiment, the frame inversion driving method is exemplified hereinafter for convenience of description.

According to the frame inversion driving method as described above, the polarity of the frame changes per frame. In this case, the controller 150 can select the sub-pixels used to represent the frame color at preset frame periods, such that the sum of the polarity of the sub-pixels in the corresponding frame period is zero.

FIG. 2B is a detailed block diagram of the LCD 100 of FIG. 2A. Referring to FIG. 2B, the display panel part 110 is includes gate lines GL1 through GLn that cross data lines DL1 through DLm and R, G, and B sub-pixels PR, PG and PB are formed in the intersections of the crossed lines. The adjacent R, G and B sub-pixels PR, PG and PB correspond to one pixel. That is, each pixel includes an R sub-pixel PR representing red R, a G sub-pixel PG representing green G, and a B sub-pixel PB representing blue B. Thus, each pixel represents the color of an object with the three colors of red R, green G, and blue B. The sub-pixels PR, PG and PB each include a pixel electrode and a common electrode. As the liquid crystal arrangement is changed by an electric field formed by an electric potential difference between the two electrodes, a light transmittance varies accordingly. TFTs formed at the intersections of the gate lines GL1 through GLn and the data lines DL1 through DLm supply the video data output from the data lines DL1 through DLm, i.e., the red R, green G, and blue B data, to the pixel electrode of the sub-pixels PR, PG and PB in response to scan pulses from the gate lines GL1 through GLn.

The controller 150 controls the data driver 121, the gate driver 122, and the backlight driver 140, and supplies the three-color data of the red R, the green G, and the blue B colors fed, for example, from a graphic card of the system, to the data driver 121.

The data driver 121 converts the red R, green G, and blue B data fed from the controller 150 as a digital signal to an analog data voltage, and provides the analog data voltage to the data lines DL1 through DL2.

The data driver 121 may provide the data signal corresponding to a field to the panel display part 110 by dividing a frame duration into three R, G, and B field intervals.

The gate driver 122 may supply scan pulses for selecting a horizontal line to provide the data to the gate lines GL1 through GLn in sequence. Herein, the scan pulses may be alternately supplied with the even lines and the odd lines.

Although not shown, the LCD 100 may further include an inverter which applies AC voltage and current to the backlight part 130, a reference gamma voltage generator which generates and supplies a reference gamma voltage to the data driver 121, and a voltage generator which supplies a driving voltage to drive the device and a common voltage Vcom to the common electrode of the display panel part 110.

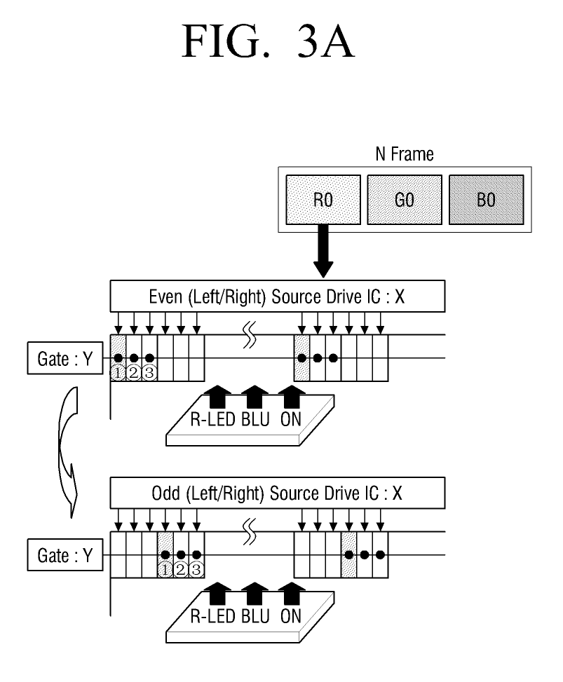

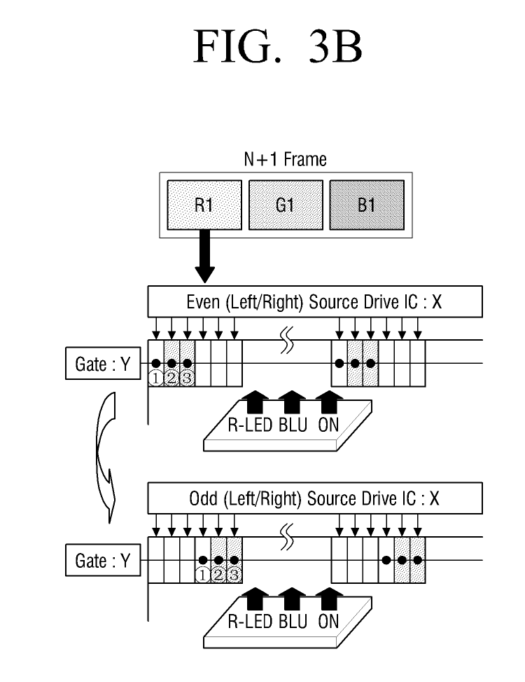

FIGS. 3A and 3B depict LCD driving methods according to an exemplary embodiment. As shown in FIGS. 3A and 3B, a data image signal of a frame may be applied in order of a red image signal, a green image signal, and a blue image signal. That is, one frame may be divided into a red field (hereinafter referred to as an R field), a green field (hereinafter referred to as a G field), and a blue field (hereinafter referred to as a B field) on a time basis, which has been described in detail above and shall not be further explained hereinafter.

FIG. 3A depicts a driving scheme of sub-pixels in an N-th frame. To facilitate an understanding of the exemplary embodiments, in the R field, for example, when the red image signal is input, only a first sub-pixel \textcircled{1} of the three sub-pixels of one pixel is selected to represent the red image signal, though it is understood that another exemplary embodiment is not limited thereto. That is, only the first sub-pixel \textcircled{1} can be used to project the emitting red light corresponding to the R field. In this case, the other two sub-pixels, i.e., a second sub-pixel \textcircled{2} and a third sub-pixel \textcircled{3}, can be controlled to not transmit the red light. For example, the second sub-pixel \textcircled{2} and the third sub-pixel \textcircled{3} can be controlled to represent the gray or black color.

By repeating this process, the first, second, and third \textcircled{1}, \textcircled{2} and \textcircled{3} sub-pixels are controlled per 1/60^{th} of a second. Herein, the order of the light transmittance of the sub-pixel may be determined by a temporal and spatial sub-pixel control scheme.

In the meantime, according to the field sequential driving method as described above, since the data signal is displayed three times during each field, the RGB driving time is reduced by ⅓rd compared to the related art LCD. Furthermore, since color filters are not utilized in the present exemplary embodiment, light intensity increases.

For example, the light intensity of two consecutive frames may be the same based on the following equation:

[N]frame[1/3×2]+[N+1]frame[2/3×2]=6/3=2. [Equation 1]

Since the light intensity for two frames is 2, the light intensity for one frame can be 1 on average.

FIG. 3B depicts a sub-pixel driving scheme in an (N+1)-th frame. Referring to FIG. 3B, when the first sub-pixel \textcircled{1} is used to project the corresponding light, i.e., the red light in the N-th frame as shown in FIG. 3A, the second sub-pixel \textcircled{2} and the third sub-pixel \textcircled{3} can be used to properly project the red light in the (N+1)-th frame as shown in FIG. 3B. In this case, the remaining sub-pixel, i.e., the first sub-pixel \textcircled{1}, can be controlled to not project the red light. For example, the first sub-pixel \textcircled{1} can be controlled to represent the gray or black color.

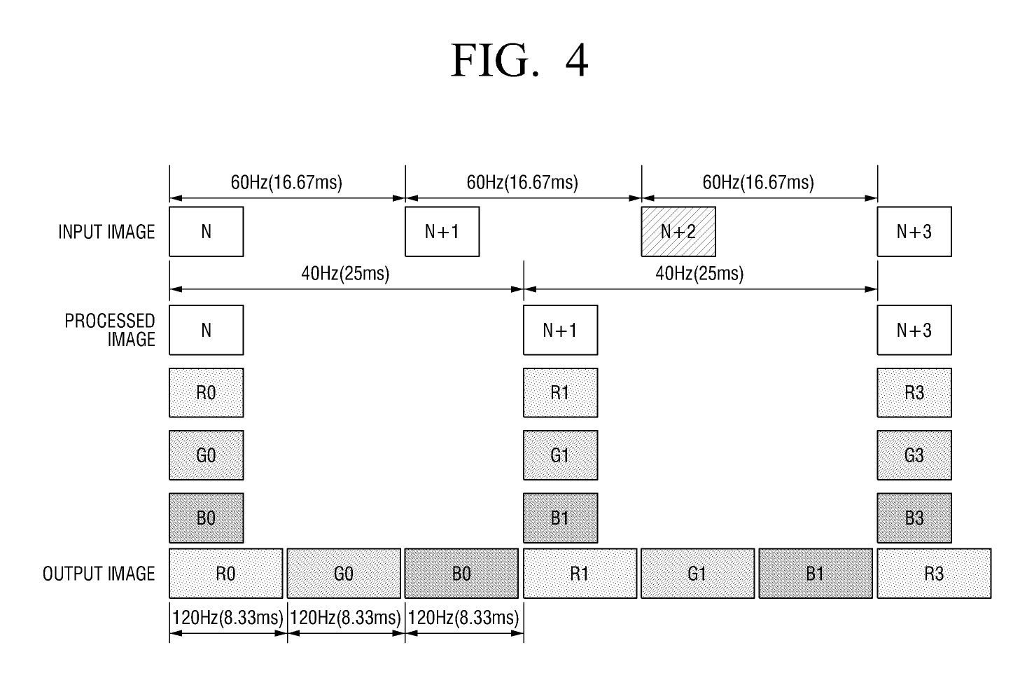

FIG. 4 illustrates a field sequential driving method according to an exemplary embodiment. While not limited thereto, for convenience of description, the present exemplary embodiment assumes that an input is 60 Hz, and an output panel of 120 Hz is used.

Referring to FIG. 4, in the 120 Hz panel, R, G and B LED backlights can be iterated at 40 Hz intervals. Hence, during one frame period, the R, G and B LED backlights are switched on once.

Specifically, the field sequential driving scheme divides the whole frame (1 frame=16.7 ms) on the liquid crystal panel into R, G, and B fields or sub-frames (1 sub-frame=5.56 ms).

For example, each sub-frame is divided into a data write time (AP=1.69 ms), a liquid crystal response time (WP=1.5 ms), and a backlight drive time (FP=2.37 ms) through the TFT scan. The backlight drive time FP according to the actual color is a time excluding the data write time AP and the liquid crystal response time WP. The data write time AP is a gate-on time of the scan pulse applied to the gate lines of the liquid crystal panel in sequence, and is a value corresponding to 1 Horizontal (H) period.

The pixel data of the red, green, and blue colors of the liquid crystal panel are sequentially generated once at the rate of R:G:B=1:1:1 within one vertical period. The backlight unit is also synchronized in the same or similar manner and the light sources (e.g., the LEDs) of the red, the green, and the blue colors are switched on in order.

While the 120 Hz panel is exemplified in the present exemplary embodiment, it is understood that another exemplary embodiment is not limited thereto. For example, another exemplary embodiment is applicable to panels over 120 Hz, for example, a 240 Hz panel. Furthermore, another exemplary embodiment is applicable to panels below 120 Hz.

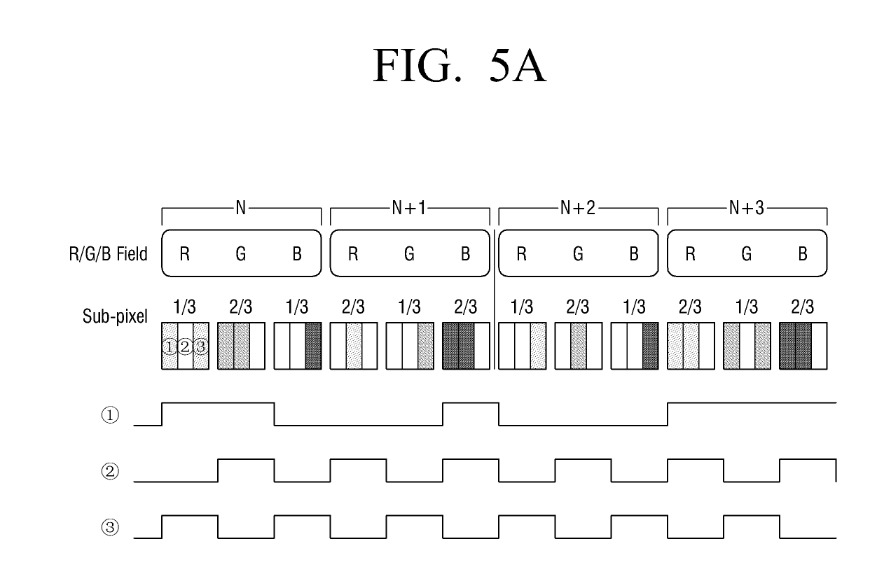

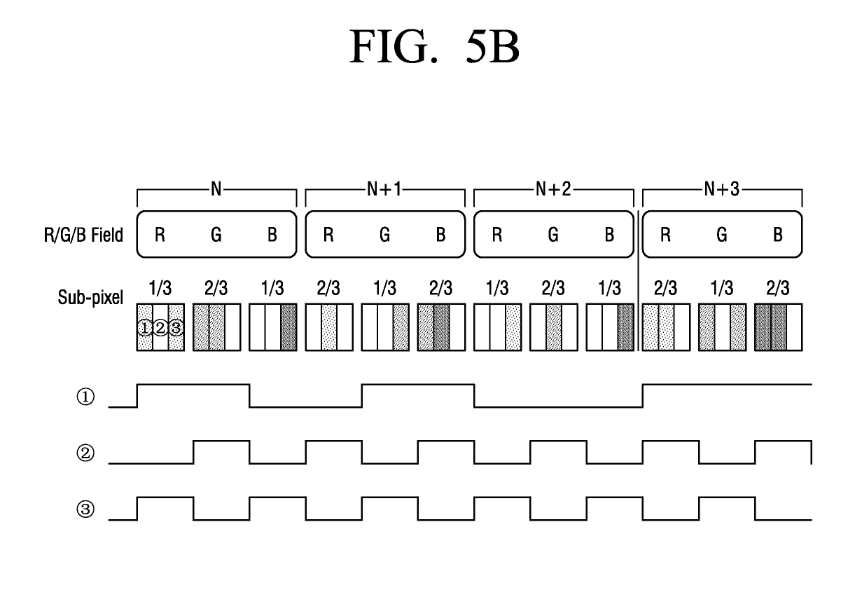

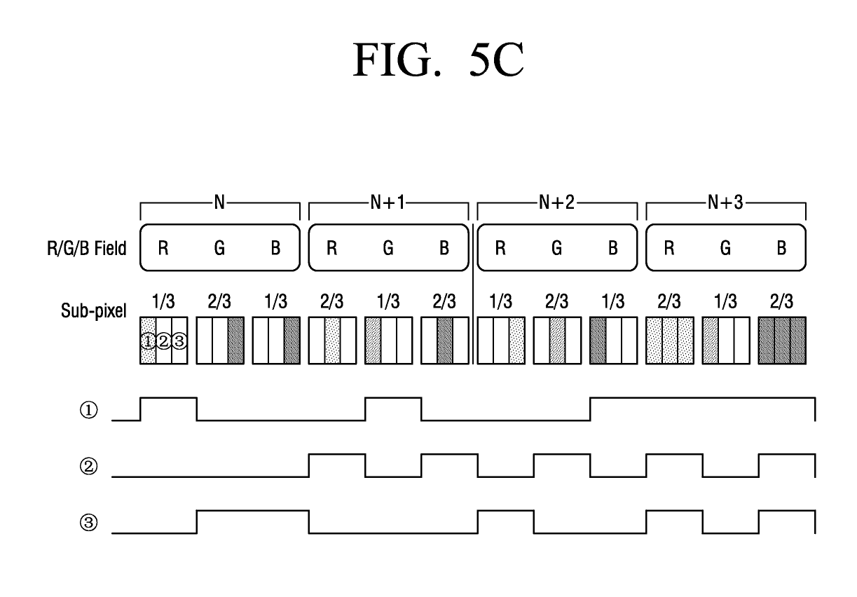

FIGS. 5A, 5B and 5C illustrate a sub-pixel driving method according to one or more exemplary embodiments.

Referring to FIG. 5A, an R field can project light using first \textcircled{1} and third \textcircled{3} sub-pixels in an N-th frame and a second \textcircled{2} sub-pixel in an (N+1)-th frame.

A G field can project light using the first \textcircled{1} and the second \textcircled{2} sub-pixels in the N-th frame and the third \textcircled{3} sub-pixel in the (N+1)-th frame.

A B field can project light using the third \textcircled{3} sub-pixel in the N-th frame and the first \textcircled{1} and the second \textcircled{2} sub-pixels in the (N+1)-th frame.

That is, each sub-pixel can be driven for use for the same number of times in the N-th frame and the (N+1)-th frame, i.e., in the two frames. Moreover, the sub-pixels can be driven to use for the same number of times per every two frames in the remaining frames as well.

In this case, the first \textcircled{1}, the second \textcircled{2}, and the third \textcircled{3} sub-pixels are switched on for 1/60th of a second per every 1/30th of a second. The ON/OFF cycle of each sub-pixel is set by taking into account the sub-pixel polarity in each frame, which will be described in more detail below.

As shown in FIG. 5A, the first \textcircled{1} sub-pixel can be driven to project the corresponding light from the R and G fields of the N-th frame, the B field of the (N+1)-th frame, and the R, G and B fields of the (N+3)-th frame.

The second \textcircled{2} sub-pixel can be driven to project the corresponding light from the G field of the N-th frame, the R and B fields of the (N+1)-th frame, the G field of the (N+2)-th frame, and the R and B fields of the (N+3)-th frame.

The third \textcircled{3} sub-pixel can be driven to project the corresponding light from the R and B fields of the N-th frame, the G field of the (N+1)-th frame, and the R and B fields of the (N+2)-th frame, and the G field of the (N+3)-th frame.

Referring to FIG. 5B, the R field can project light using the first \textcircled{1} and the third \textcircled{3} sub-pixels in the N-th frame and the second \textcircled{2} sub-pixel in the (N+1)-th frame.

The G field can project light using the first \textcircled{1} and the second \textcircled{2} sub-pixels in the N-th frame and the third \textcircled{3} sub-pixel in the (N+1)-th frame.

The B field can project the light using the third \textcircled{3} sub-pixel in the N-th frame and the first \textcircled{1} and the second \textcircled{2} sub-pixels in the (N+1)-th frame.

That is, the sub-pixels can be driven for use for a same number of times in the N-th frame and the (N+1)-th frame, i.e., in the two frames. Furthermore, the sub-pixels can be driven for use for the same number of times per every two frames in the remaining frames as well.

As shown in FIG. 5B, the first \textcircled{1} sub-pixel can be driven to project the corresponding light from the R and G fields of the N-th frame, the B field of the (N+1)-th frame, and the R, G, and B fields of the (N+3)-th frame.

The second \textcircled{2} sub-pixel can be driven to project the corresponding light from the G field of the N-th frame, the R and B fields of the (N+1)-th frame, the G field of the (N+2)-th frame, and the R and B fields of the (N+3)-th frame.

The third \textcircled{3} sub-pixel can be driven to project the corresponding light from the R and B fields of the N-th frame, the G field of the (N+1)-th frame, the R and B fields of the (N+2)-th frame, and the G field of the (N+3)-th frame.

Referring to FIG. 5C, the R field can project light using the first \textcircled{1} sub-pixel in the N-th frame, the second \textcircled{2} sub-pixel in the (N+1)-th frame, and the third \textcircled{3} sub-pixel in the (N+2)-th frame.

The G field can project light using the third \textcircled{3} sub-pixel in the N-th frame, the first \textcircled{1} sub-pixel in the (N+1)-th frame, and the second \textcircled{2} sub-pixel in the (N+2)-th frame.

The B field can project light using the third \textcircled{3} sub-pixel in the N-th frame, the second \textcircled{2} sub-pixel in the (N+1)-th frame, and the first \textcircled{1} sub-pixel in the (N+2)-th frame.

The sub-pixels can be used for a same number of times in the N-th frame, the (N+1)-th frame, and the (N+2)-th frame. Moreover, the sub-pixels can be driven and used for the same number of times per every three frames in the remaining frames as well.

As shown in FIG. 5C, the first \textcircled{1} sub-pixel can be driven to project the corresponding light from the R field of the N-th frame, the G field of the (N+1)-th frame, the B field of the (N+2)-th frame, and the R, G and B fields of the (N+3)-th frame.

The second \textcircled{2} sub-pixel can be driven to project the corresponding light from the R and B fields of the (N+1)-th frame, the G field of the (N+2)-th frame, and the R and B fields of the (N+3)-th frame.

The third \textcircled{3} sub-pixel can be driven to project the corresponding light from the G and B fields of the N-th frame, the R field of the (N+2)-th frame, and the R and B fields of the (N+3)-th frame.

As stated above, each sub-pixel can be used for the same number of times in the preset number of the frames. While the preset number of the frames is two and three in the above-described exemplary embodiments, another exemplary embodiment is not limited thereto, and the preset number of the frames can be variously designed and modified.

The preset number of the frames may vary by intervals in an exemplary embodiment. For example, although the sub-pixels are used for the same number of times in the first and second frames, the sub-pixels can be used for the same number of times in the next three frames (i.e., the third, fourth and fifth frames).

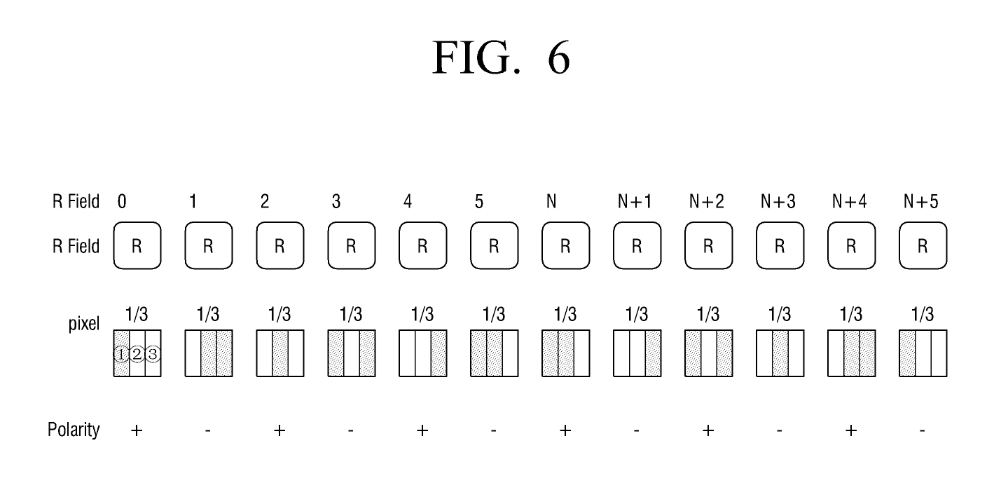

FIG. 6 illustrates a sub-pixel driving method by considering a pixel polarity according to an exemplary embodiment.

According to a frame inversion driving method of the present exemplary embodiment, a same polarity of data voltage can be applied to a liquid crystal with respect to a common electrode voltage on a frame basis. For example, referring to FIG. 6, when a data voltage of a positive polarity is applied to an even frame, a data voltage of a negative polarity is applied to an odd frame.

While the R field alone of the frame is illustrated in order to ease an understanding of the exemplary embodiment illustrated in FIG. 6, it is understood that another exemplary embodiment may be applied to other fields e.g., to the G and B fields.

A selective driving manner of a sub-pixel may be determined by taking account of a polarity of a corresponding pixel. For example, sub-pixels used to represent a frame color can be selected at preset frame periods to make a sum of the polarity of the sub-pixels in the corresponding frame period zero.

For example, a first \textcircled{1} sub-pixel of FIG. 6 can be used to project the corresponding light in a zero frame of a (+) polarity and a third frame of a (−) polarity, and not used to project the corresponding light in first and second frames of the (−) polarity and the (+) polarity, respectively. That is, in the four frames, i.e., the zero through third frames the sum of the polarity of the first \textcircled{1} sub-pixel is zero.

The second \textcircled{2} sub-pixel may be used to project the corresponding light in the first frame of the (+) polarity and the second frame of the (−) polarity, and not used to project the corresponding light in the zero and third frames of the (−) polarity and the (+) polarity, respectively. That is, in the four frames, i.e., the zero through third frames, the sum of the polarity of the first \textcircled{1} sub-pixel is zero.

In the four frames, i.e., the zero through third frames, the sum of the polarity of the second \textcircled{2} sub-pixel is not zero. In some cases, when the number of times the sub-pixels are used is set to be the same, the sum of the polarity of the sub-pixels is not always zero. That is, according to a modification by one skilled in the art, the sum of the polarity may not be zero in one or more other exemplary embodiments.

The first \textcircled{1}, the second \textcircled{2}, and the third \textcircled{3} sub-pixels are used for the same number of times (i.e., once) in the zero and first frames and for the same number of times (i.e., once) in the second and third frames as well. Even when the zero, first, second and third frames are averaged, the first \textcircled{1}, the second \textcircled{2}, and the third \textcircled{3} sub-pixels are used for the same number of times (i.e., twice).

Hence, since a DC component approaches zero while not leaning toward one polarity, a stress of a liquid crystal is reduced and a direct-current afterimage can be suppressed.

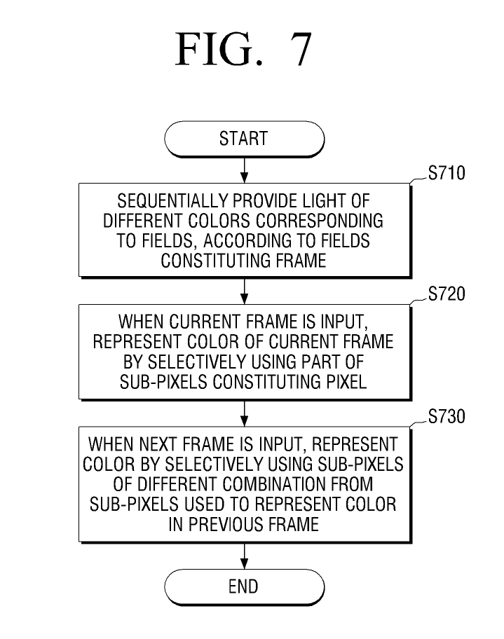

FIG. 7 is a flowchart of the LCD driving method according to an exemplary embodiment.

Referring to FIG. 7, light of different colors corresponding to fields according to the fields of a frame is provided (operation S710).

When a current frame is input, a color of the current frame is represented by selectively using part of sub-pixels of a pixel (operation S720).

When a next frame is input, a color is represented by selectively using sub-pixels of a different combination from the sub-pixels used to represent the color in the previous frame (operation S730).

The method according to the present exemplary embodiment can sequentially select the sub-pixels used to represent the frame color in every frame so that the number of times the sub-pixels of the pixels are used equal.

For example, in every two frames, the sub-pixels can be selected to cause the number of times the sub-pixels in the corresponding frames are used to be equal.

Among the plurality of the sub-pixels, unselected sub-pixels can be driven to reduce the transmittance of the unselected sub-pixel.

For example, the unselected sub-pixel of the sub-pixels can be driven to represent a gray or a black color.

A frame inversion driving scheme according to an exemplary embodiment can select sub-pixels used to represent a frame color such that a polarity of the frame changes per frame and a sum of a polarity of sub-pixels in the corresponding frame period becomes zero at the preset frame periods.

An LCD according to an exemplary embodiment can be provided without color filters, i.e., the LCD can be driven according to an FSC driving scheme of an exemplary embodiment.

Furthermore, an LCD according to an exemplary embodiment can be applied to a DID device.

In light of the foregoing as set forth, by applying a field sequential driving scheme and a sub-pixel control scheme to an LCD according to an exemplary embodiment, with color filters not utilized, a liquid crystal stress can be drastically improved without loss of brightness.

While not restricted thereto, an exemplary embodiment can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, while not required in all exemplary embodiments, one or more units of the LCD 100 can include a processor or microprocessor executing a computer program stored in a computer-readable medium, such as a local storage.

Although a few exemplary embodiments have been shown and described, it would be appreciated by those skilled in the art that changes may be made in these exemplary embodiments without departing from the principles and spirit of the inventive concept, the scope of which is defined in the claims and their equivalents.

What is claimed is:

1. A Liquid Crystal Display (LCD) comprising:
a display panel part comprising a pixel, the pixel comprising a plurality of sub-pixels;
a panel driver which drives the plurality of sub-pixels;
a backlight part which emits light of different colors to the display panel part;
a backlight driver which provides the light of the different colors corresponding to fields of a frame in sequence by sequentially driving the backlight part according to the fields; and
a controller which controls the panel driver to represent a color of the pixel of the frame by selectively using one or more of the sub-pixels of the pixel.

2. The LCD of claim 1, wherein the controller uses a different sub-pixel combination used to represent a frame color, in every frame.

3. The LCD of claim 2, wherein the controller sequentially selects sub-pixels of pixels used to represent a color of the frame in every frame so as to cause a number of times the sub-pixels of the pixels of the display panel part are used in each frame to be equal.

4. The LCD of claim 2, wherein the controller sequentially selects sub-pixels of pixels used to represent a color of the frame in every N number of frames to cause a number of times the sub-pixels are used in the every N number of frames to be equal, where N is a natural number greater than 1.

5. The LCD of claim 1, wherein the panel driver drives an unselected sub-pixel of the sub-pixels to reduce a light transmittance of the unselected sub-pixel.

6. The LCD of claim 5, wherein the panel driver drives the unselected sub-pixel of the sub-pixels so that the unselected sub-pixel represents a gray or a black color.

7. The LCD of claim 1, wherein:
a polarity of the frame changes on a frame-by-frame basis; and
the controller selects sub-pixels of pixels used to represent a color of the frame at preset frame periods to cause a sum of a polarity of the sub-pixels in the corresponding frame period to be zero.

8. The LCD of claim 1, wherein the LCD is without color filters.

9. A Digital Information Display (DID) device comprising the LCD of claim 1.

10. A method of driving a Liquid Crystal Display (LCD), the method comprising:
providing light of different colors corresponding to fields of a frame in sequence according to the fields;
when a current frame is input, representing a color of a pixel of the LCD by selectively using one or more of sub-pixels of the pixel; and
when a next frame is input, representing a color of the pixel by selectively using one or more of the sub-pixels,
wherein a sub-pixel combination used to represent a frame color of the current frame is different from a sub-pixel combination used to represent a frame color of the next frame.

11. The method of claim 10, wherein sub-pixels of pixels used to represent each frame color are selected in sequence in every frame so as to cause a number of times the sub-pixels of the pixels are used to be equal.

12. The method of claim 10, wherein sub-pixels of pixels used to represent each frame color are selected in every N number of frames to cause a number of times the sub-pixels are used in the every N number of frames to be equal, where N is a natural number greater than 1.

13. The method of claim 10, wherein an unselected sub-pixel of the sub-pixels is driven to reduce a light transmittance of the unselected sub-pixel.

14. The method of claim 13, wherein the unselected sub-pixel of the sub-pixels is driven so that the unselected sub-pixel represents a gray or a black color.

15. The method of claim 10, wherein:
a polarity of the frame changes on a frame-by-frame basis; and
sub-pixels of pixels used to represent each frame color are selected at preset frame periods to cause a sum of a polarity of the sub-pixels in the corresponding frame period to be zero.

16. The method of claim 10, wherein the LCD does not include a color filter.

17. The method of claim 10, wherein the LCD is used in a Digital Information Display (DID) device.

18. A method of driving a display panel, the method comprising:
when a current frame is input, representing a color of a pixel of the display panel by selectively using one or more of sub-pixels of the pixel; and
when a next frame is input, representing a color of the pixel by selectively using one or more of the sub-pixels,
wherein a sub-pixel combination used to represent a frame color of the current frame is different from a sub-pixel combination used to represent a frame color of the next frame, and
the sub-pixels provide light of different colors corresponding to fields of each frame in sequence according to the fields.

19. A computer readable recording medium having recorded thereon a program executable by a computer for performing the method of claim 10.

20. A computer readable recording medium having recorded thereon a program executable by a computer for performing the method of claim 18.
